(19) United States
(12) Patent Application Publication
(10) Pub. No.: US 2016/0132926 A1
(43) Pub. Date: May 12, 2016

(54) Systems and Methods for Coordinated Advertising Campaigns

(71) Applicant: Criteo SA, Paris (FR)

(72) Inventors: Stephen John Zimmerman, JR., Los Angeles, CA (US); Behzad Zamanzadeh, Tarzana, CA (US); Xiaofeng Wu, Los Angeles, CA (US); Alissa Volosin, Los Angeles, CA (US)

(73) Assignee: Criteo SA

(21) Appl. No.: 14/939,534

(22) Filed: Nov. 12, 2015

Related U.S. Application Data
(60) Provisional application No. 62/078,817, filed on Nov. 12, 2014.

(51) Int. Cl. G06Q 30/02

(52) U.S. Cl. CPC G06Q 30/0255; G06Q 30/0277

(57) ABSTRACT

Systems and methods for generating coordinated advertising campaigns in accordance with embodiments of the invention are disclosed. In one embodiment, a coordinated product advertising server system includes a processor and a memory connected to the processor and storing a product advertisement generation application, wherein the product advertisement generation application directs the processor to obtain product feed data, determine a set of advertising channel data, wherein advertising channel data includes metadata describing attributes of an advertising channel, generate a set of advertising creatives for each advertising channel based on the product feed data and the set of advertising channel data, generate a set of product advertising campaigns, wherein an advertising campaign is targeted to a specific advertising channel and includes the set of advertising creatives for the specific advertising channel, and transmit each product advertising campaign to the specific advertising channel associated with the product advertising campaign.

### CROSS-REFERENCE TO RELATED APPLICATIONS

The instant application claims priority to U.S. Provisional Patent Application No. 62/078,817, titled “Systems and Methods for Coordinated Advertising Campaigns” and filed Nov. 12, 2014, the disclosure of which is hereby incorporated by reference in its entirety.

### FIELD OF THE INVENTION

The present invention relates to targeted search advertising and more specifically to the creation of product advertising campaigns.

### BACKGROUND

The term e-commerce is used to refer to the buying and selling of products or services over electronic systems such as the Internet and other computer networks. The amount of trade conducted via e-commerce has grown extraordinarily with widespread Internet usage. As a result, a variety of websites have been established to offer goods and services.

Search engines are useful tools for locating specific pages of information on the World Wide Web and are increasingly used to locate goods and services. As a result, many websites use search advertising/search engine marketing to attract visitors to product, service, and/or category landing pages. Search advertising describes the placement of online advertisements adjacent or amongst the search results returned by a search engine in response to a specific search query. Search engine marketing typically involves paying for a specific online advertisement or creative to be featured in or adjacent to the search results provided in response to a specific query. Typically, the position of an advertisement within the returned search results is a function of the bid scaled by a quality factor that measures the relevance of the creative and landing page combination to the search query. Accordingly, the provider of the search engine is incentivized to feature relevant keyword/advertisement/landing page combinations so that users will select featured advertisements and increase the revenue generated by the search engine provider. In the context of paid search advertising, the term keyword refers to both a single word and a specific combination of words or keyword components.

When a website includes a large number of products or services, the process of building and managing a paid search advertising campaign can be quite complex. Many search engines provide the ability to upload an entire advertising campaign including one or more creatives that target a set of keywords, and associated bids to be used when the display of the creative is triggered by specific keywords. For example, Google, Inc. of Mountain View, California, defines an Ad Group file format that enables advertisers to upload paid search advertising campaigns.

### SUMMARY OF THE INVENTION

Systems and methods for generating coordinated advertising campaigns in accordance with embodiments of the invention are disclosed. In one embodiment, a coordinated product advertising server system includes a processor and a memory connected to the processor and storing a product advertisement generation application, wherein the product advertisement generation application directs the processor to obtain product feed data, determine a set of advertising channel data, wherein advertising channel data includes metadata describing attributes of an advertising channel, generate a set of advertising creatives for each advertising channel based on the product feed data and the set of advertising channel data, generate a set of product advertising campaigns, wherein an advertising campaign is targeted to a specific advertising channel and includes the set of advertising creatives for the specific advertising channel, and transmit each product advertising campaign to the specific advertising channel associated with the product advertising campaign.

### BRIEF DESCRIPTION OF THE DRAWINGS

FIG. 1 is a conceptual illustration of a coordinated product advertising system in accordance with an embodiment of the invention.

FIG. 2 is a conceptual illustration of a coordinated product advertising server system in accordance with an embodiment of the invention.

FIG. 3 is a flow chart illustrating a process for building coordinated advertising campaigns in accordance with an embodiment of the invention.

FIG. 4 is a flow chart illustrating a process for generating a targeting advertising campaign in accordance with an embodiment of the invention.

FIG. 5 is a flow chart illustrating a process for generating a product listing advertising campaign in accordance with an embodiment of the invention.

FIG. 6 is a flow chart illustrating a process for generating an online social network advertising campaign in accordance with an embodiment of the invention.

FIG. 7 is a flow chart illustrating a process for generating product titles in accordance with an embodiment of the invention.

FIG. 8 is a flow chart illustrating a process for re-targeting of advertisement data in accordance with an embodiment of the invention.

FIG. 9 is a flow chart illustrating a process for generating global performance data in accordance with an embodiment of the invention.

### DETAILED DESCRIPTION

Turning now to the drawings, systems and methods for coordinated product advertising campaigns in accordance with embodiments of the invention are disclosed. In a variety of product advertising campaigns, advertisements presented to users (e.g. the advertising creative) includes an image and a title (or any other tagline) describing the product. As such, it is extremely important to have advertisements that clearly describe the attributes of the product in a way that users will be encouraged to engage with the presented advertisement. In particular, particular advertisements may perform differently in different advertising channels and the attributes presented in the advertisement can vary between advertising channels. In many embodiments, a product advertising campaign is generated for a set of products described in a product data feed. The product data feed can contain a variety of information, such as keywords describing the products and/or categories of products, images illustrating the products, references to landing pages containing more information about the products, and any other data that is relevant to the products being advertised as appropriate to the requirements of specific applications of embodiments of the invention.

In many embodiments, generating a product advertising campaign utilizes a taxonomy. The term taxonomy is used to describe a particular scheme for classifying products and/or services. Collectively products and/or services (indeed any object, person, idea, or action) can be referred to as a concept and, in many embodiments, concepts can be defined in terms of categories and attribute value pairs. In this way, a taxonomy used to build product advertising campaigns can also include elements of a taxonomy and/or an ontology in the sense that the possible attributes of classified concepts and groupings of concepts can also be specified, as can the relationships (including hierarchical relationships) between those attributes. The taxonomy can also be used to identify relationships between keyword components and the categories and attributes within the taxonomy and these relationships used to identify potentially relevant attributes for use in creating product targets within a product advertising campaign, such as name patterns (e.g. how a product name is displayed) and phrase patterns (e.g. how the details of a product are displayed). In several embodiments, a taxonomy includes categories, attributes, and/or keywords used in a variety of search queries and/or content posted on a third-party content site. The taxonomy can also be constructed based on the categories and attributes associated with any of a variety of advertising campaigns and/or product data feeds across one or more advertising channels. In this way, the taxonomy can identify relationships between keywords that can be globally utilized across advertising campaigns and advertising channels. Furthermore, the taxonomy can include performance data related to the categories, attributes, and/or keywords across one or more advertising channels. This performance data can be based on any metric relevant to the requirements of specific applications in accordance with embodiments of the invention, such as, but not limited to, impressions of and/or engagement with particular categories, attributes, and/or keywords.

A product target and associated product data can be combined to form the specific product advertisement that is displayed. The product advertisement can be designed to direct users to a landing page affiliated with the product target and/or the product data. Different products can be displayed with respect to the same landing page according to the advertising channel in which the advertisement is displayed. Product advertising server systems can generate product advertising campaigns including a plurality of product targets based on a product data feed containing one or more products, where a product can be defined as a set of attribute-value (e.g. attribute-keyword) pairs. Products can be grouped into one or more groups of products based on the attributes and values associated with each of the products. In a variety of embodiments, a product advertising campaign includes a set of categories and attributes along with keywords provided by a user. These keywords can include, but are not limited to, search queries provided by the user searching for a particular good and/or service and content posted to third-party content sites as appropriate to the requirements of specific applications of embodiments of the invention. The product advertising campaign can be transmitted to any third party, such as a search engine provider, an online social network, or any other third-party content provider.

Additionally, categories and/or attributes for a particular product (or advertising campaign) can be inferred based on the categories, attributes, and/or values within the taxonomy and the inferred data can then be utilized to generate advertising data. As described in more detail below, these inferred attributes can be utilized to generate advertising campaigns that utilize categories and/or attributes not present in a product data feed describing a set of products. In this way, effective or optimal product advertisements can be generated based on the attributes of products and product targets that are likely to perform well with respect to specific advertising channels for each product advertising campaign. Users can interact with the advertising creative and be presented with product information provided at the landing page described in the product advertisement. Additionally, user data can be utilized to track users across one or more advertising channels. In several embodiments, the user data is utilized to target advertisements to the user across one or more channels and/or to generate advertisements that are specifically targeted to the user.

Performance data describing the display and engagement with the advertisements can be measures and associated with the categories, attributes, and/or keywords present in the displayed advertisements for each advertising channel. This performance data can then be utilized to modify and improve the advertising campaigns across multiple advertising channels. In a variety of embodiments, the taxonomy is utilized to encode performance data describing the performance of particular categories, attributes, and/or keywords obtained for one or more advertising campaigns. The encoded performance data for one or more of the advertising campaigns can also be anonymized and/or aggregated to generate global performance data describing the performance data across multiple advertising campaigns and/or channels. The encoded performance data can be stored alongside the taxonomy and/or stored separately. The taxonomy and/or performance data can be stored using any of a variety of storage techniques, such as a database, spreadsheet, flat file, or any other storage technique as appropriate to the requirements of specific applications of embodiments of the invention. Furthermore, particularly in those embodiments in which the encoded performance data is stored separately from the taxonomy, the encoded performance data can include references to the taxonomy in that particular subsets of the performance data can be associated with one or more categories, attributes, and/or keywords stored within the taxonomy as appropriate to the requirements of specific applications of embodiments of the invention.

Although much of the discussion that follows relates to product advertising campaigns, similar systems and methods in accordance with embodiments of the invention can be used to generate targets in product listing advertising campaigns can also be utilized to generate product data streams. Product data streams (e.g. product data feeds) can contain attribute-value pairs describing products and/or services. In many embodiments, the product data stream describes the products that are being advertised within the product listing advertising campaign. Furthermore, while advertising campaigns are often referred to with respect to products, services and any other subjects of advertising campaigns can be utilized in accordance with embodiments of the invention. Systems and methods for generating and/or updating coordinated product advertising campaigns in accordance with embodiments of the invention are discussed below.

### Coordinated Product Advertising Systems

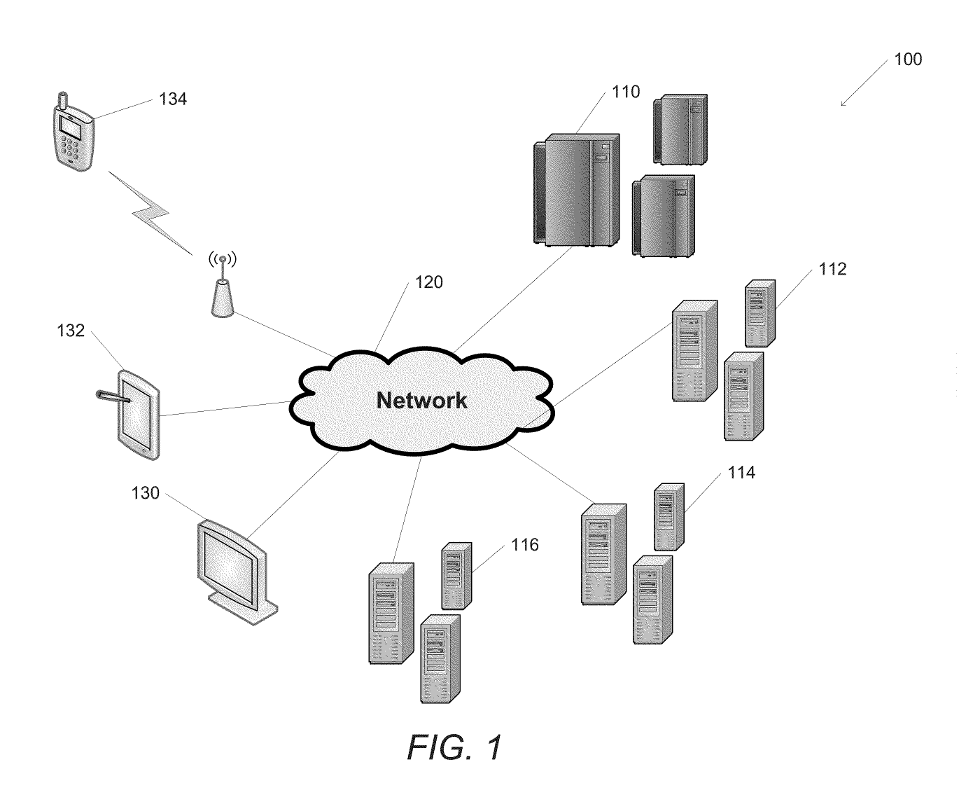

Coordinated product advertising systems can generate and deliver product advertisements to user devices across multiple advertising channels. Coordinated product advertising server systems in accordance with many embodiments of the invention create product advertising campaigns using product targets targeted toward the search terms used to search for the products and/or services that are related to the products advertised in the product advertising campaign and/or deploy product advertising campaigns. A conceptual diagram of a coordinated product advertising system in accordance with an embodiment of the invention is shown in FIG. 1. The coordinated product advertising system 100 includes a coordinated product advertising server system 110, a search engine provider 112, a product data server system 114, third-party content systems 116, and user devices including computers 130, tablets 132, and mobile phones 134 communicating via a network 120. In a variety of embodiments, the network 120 is the Internet. In a number of embodiments, the coordinated product advertising server system 110 and/or product data server system 114 is implemented using a single server system. In several embodiments, the coordinated product advertising server system 110 and/or product data server system 114 is implemented using multiple server systems.

The coordinated product advertising server system 110 can create product advertising campaigns based on a product data feed including one or more pieces of product data and one or more taxonomies describing schemes for categorizing the product data. In a variety of embodiments, the product data feed is obtained from the product data server system 114 and/or the third-party content system 116. In a number of embodiments, the coordinated product advertising server system 110, the product data server system 114, and/or the third-party content system 116 are a single system. In many embodiments, the coordinated product advertising server system 110 further generates product advertising campaigns for multiple advertising channels. Product advertising channels include, but are not limited to, targeted advertising campaigns, product listing advertising campaigns, and online social network advertising campaigns.

In several embodiments, the coordinated product advertising server system 110 provides the product advertising campaign to the search engine provider 112 and/or the third-party content system 116. The search engine provider 112 can present product advertisements to the user devices based on keywords and/or phrases contained in search queries provided by the user devices to the search engine provider 112. The third-party content system 116 can present product advertisements to the user devices based on user profile information and/or content presented to the user via the service(s) (such as an online social network) provided by the third-party content system. In many embodiments, the product advertising campaign includes the advertising creative presented to the users by the search engine provider and/or third-party service. In a number of embodiments, the search engine provider 112 and/or the third-party content system 116 can generate the advertising creative presented to the user based on the product advertising campaign. Additionally, the search engine provider 112 and/or the third-party content system 116 can provide performance information, such as but not limited to the number of times an advertisement is displayed, engagement with the advertisement, and/or conversions associated with the advertisement, to the coordinated product advertising server system 110. In a variety of embodiments, the coordinated product advertising server system 110 associates performance information (including performance information across a plurality of advertising campaigns for differing advertising channels) with the categories and/or attributes within the taxonomy. In this way, the coordinated product advertising server system 110 can utilize the performance information in the generation of product advertising campaigns. Performance information can also be provided by the product data server system 114 as appropriate to the requirements of specific applications of the invention.

Although a specific architecture of a coordinated product advertising system in accordance with embodiments of the invention are discussed above and illustrated in FIG. 1, a variety of architectures, including user devices not specifically named and other methods of serving product advertising campaign information to user devices, can be utilized in accordance with embodiments of the invention. Additionally, while the above is described with respect to search engine providers, any content provider that provides advertisements to users, either alone or alongside content provided by the content provider, can be utilized as appropriate to the requirements of specific applications of embodiments of the invention. Furthermore, it should be noted that any data created and/or transferred within the system can be provided by any system in any manner (i.e. via one or more application programming interfaces (APIs) web services, and/or file-based interfaces not specifically described herein) as appropriate to the requirements of specific applications of embodiments of the invention.

### Coordinated Product Advertising Server Systems

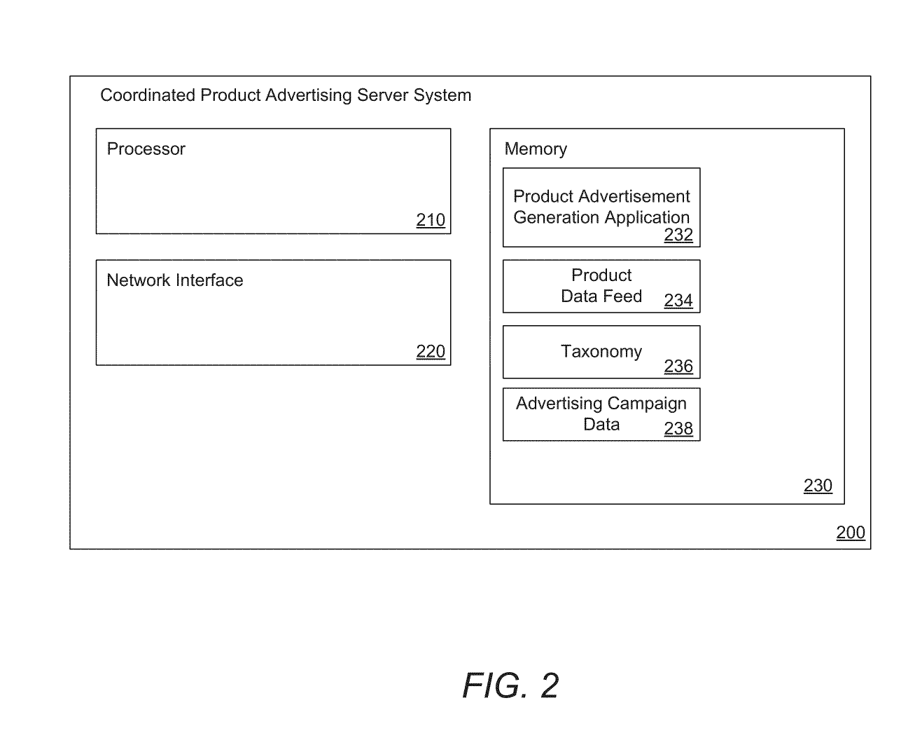

Coordinated product advertising server systems in accordance with embodiments of the invention can generate advertisements (e.g. product targets, product feed data, and/or advertising creatives) for a variety of products across a variety of advertising channels. A conceptual illustration of a coordinated product advertising server system in accordance with an embodiment of the invention is shown in FIG. 2. The coordinated product advertising server system 200 includes a processor 210 in communication with memory 230. The coordinated product advertising server system 200 also includes a network interface 220 sending and receiving data over a network connection. In a number of embodiments, the network interface 220 is in communication with the processor 210 and/or the memory 230. In several embodiments, the memory 230 is any form of storage storing a variety of data, including, but not limited to, a product advertisement generation application 232, a product data feed 234, a taxonomy 236, and advertising campaign data 238. In many embodiments, the advertising product data generation application 232, performance data 234, taxonomy 236, and/or advertising campaign data 238 are stored using an external server system and received by the coordinated product advertising server system 200 using the network interface 220.

The processor 210 is directed by the product advertisement generation application 232 to perform a variety of product advertisement generation processes. These processes include obtaining one or more product data feeds 234, where a product data feeds includes categories, attributes, keywords, images, and/or references to landing pages describing one or more products. Any other metadata describing the products can be included in a product data feed as appropriate to the requirements of specific applications in accordance with embodiments of the invention. Product advertisement generation processes can also include identifying categories (and/or sub-categories) corresponding to the products data feeds utilizing the taxonomy 236. Advertisement generation processes further include generating one or more pieces of advertising campaign data 238 for one or more advertising channels.

Although a specific architecture for a coordinated product advertising server system in accordance with an embodiment of the invention is conceptually illustrated in

FIG. 2, any of a variety of architectures, including those which store data or applications on disk or some other form of storage and are loaded into memory at runtime and systems that are distributed across multiple physical servers, can also be utilized in accordance with embodiments of the invention. In a variety of embodiments, the memory 220 includes circuitry such as, but not limited to, memory cells constructed using transistors storing instructions. Similarly, the processor 210 can include logic gates formed from transistors (or any other device) that dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices.

### Building Coordinated Product Advertising Campaigns

Product advertisement generation processes can include creating coordinated advertising campaigns for a set of products for a variety of different advertising channels, each with its own set of requirements and performance characteristics. In this way, the advertising of the products can be optimized for each advertising channel. Additionally, the features of the products being advertised can be presented in a manner that optimizes the performance of the advertisements on a per-channel basis. These insights can also be utilized to optimize the advertising creatives across advertising channels. For example, images of a particular product that have a high performance on a first advertising channel can then be utilized as the images for that product on different advertising channels. Additionally, content posted to third-party content sites (such as online social networks) can be utilized in product advertisements. For example, if a particular image of a product is identified as popular on an online social network, that image can be utilized in the advertising data for the advertising channel associated with the online social network (or any other advertising channel). In several embodiments, the performance of particular categories, attributes, keywords, and other data is described using a taxonomy, i.e. performance metadata can be associated with the categories, attributes, and/or keywords within the taxonomy. Additionally, particular products can be included (or excluded) from an advertising campaign for a particular advertising channel based on the performance of the categories, keywords, and/or attributes of the product data and the particular advertising channel. Furthermore, the total spend on the advertising campaigns can be allocated based on performance data describing how well particular products and/or particular product advertisements perform on different advertising channels.

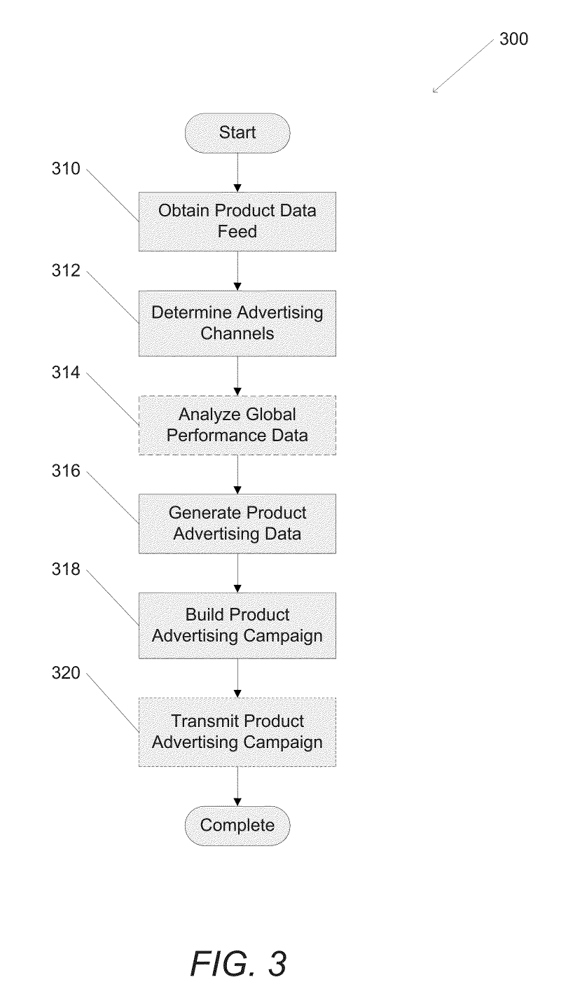

A process for creating coordinated product advertising campaigns in accordance with an embodiment of the invention is illustrated in FIG. 3. The process 300 includes obtaining (310) one or more product data feeds and determining (312) advertising channels. In a variety of embodiments, global performance data is analyzed (314). Product advertising data is generated (316) and product advertising campaigns are built (318). In many embodiments, product advertising campaigns are transmitted (320).

Although specific processes for generating coordinated product advertising campaigns in accordance with embodiments of the invention are described above with respect to FIG. 3, any number of processes, including those that modify existing advertising campaigns and those that generate multiple advertising campaigns for a single advertising channel, can be utilized as appropriate to the requirements of a specific application in accordance with embodiments of the invention.

### Generating Targeted Advertising Campaigns

Product advertisement generation processes can include utilizing a taxonomy generated in accordance with embodiments of the invention to build a campaign including a set of adgroups. Adgroups can provide search engine providers with information concerning the creative and landing page combination to display when a specific query occurs (i.e. in response to a specific target). An adgroup typically includes a landing page, at least one creative, and at least one target. However, any adgroup can be constructed appropriate to the requirements of a specific search engine provider or third-party content provider in accordance with embodiments of the invention. A creative is the specific advertisement that is displayed as part of the search engine results (or third-party content) and different creatives can be displayed with respect to the same landing page in response to different targeted search queries or third party content. Targets define the search queries or content targeted by the adgroup and can be defined in terms of any attribute of a search query or content including but not limited to keywords, keyword match type, and additional information that can derived from the search query or content such as the IP address from which the search query originated, cookies in the browser application used to provide the search query or content, and profile information associated with the user that submitted the search query or viewed or created the content. Once a campaign is deployed to a content provider (i.e. an advertising channel) such as a search engine provider and/or an online social network, the selection of creative and landing pages that are displayed in response to a keyword match can be refined to improve the performance of the overall campaign. Techniques for generating and deploying targeted advertising campaigns that can be utilized in accordance with embodiments of the invention are disclosed in U.S. Pat. No. 8,694,362, titled “Taxonomy Based Targeted Search Advertising” and issued Apr. 8, 2014, the disclosure of which is hereby incorporated by reference in its entirety.

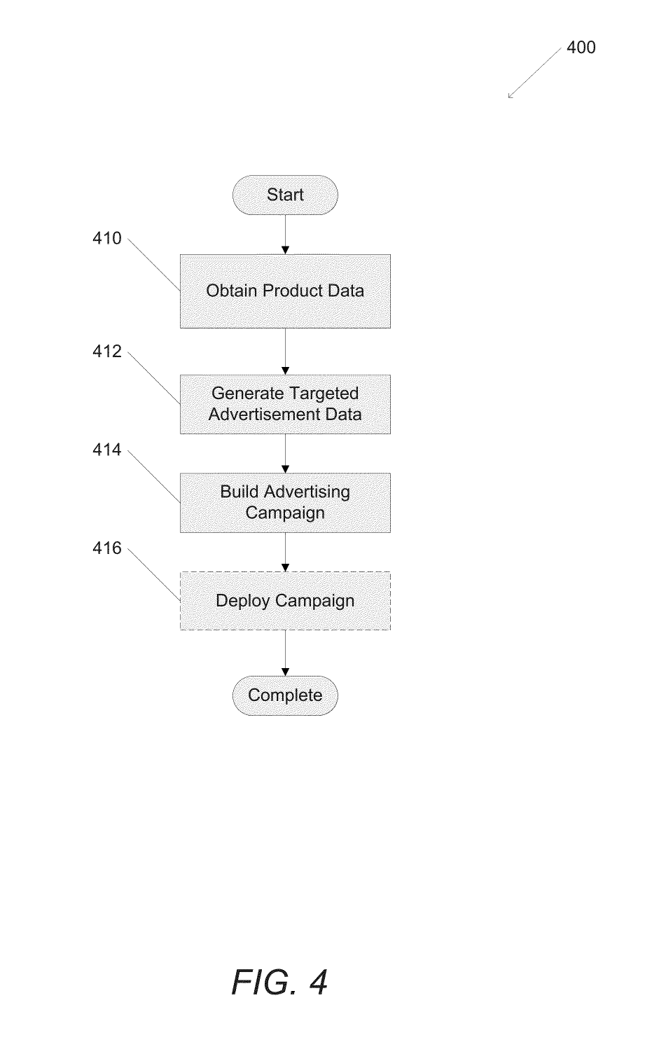

A process for generating targeted advertising campaigns in accordance with an embodiment of the invention is illustrated in FIG. 4. The process 400 includes obtaining (410) product data and generating (412) targeting advertisement data. Advertising campaigns are built (414) and, in a variety of embodiments, advertising campaigns are deployed (416).

Specific processes for generating targeted advertising campaigns in accordance with embodiments of the invention are discussed above with respect to FIG. 4; however, any of a variety of processes can be utilized in accordance with embodiments of the invention.

### Generating Product Listing Advertising Campaigns

Product listing advertising involves the presentation of product advertising campaigns designed to advertise one or more products identified as relevant to keywords in a search query (or content presented by a third-party content server) alongside the search results (or content) presented by a search engine provider or third-party content server. Product advertising campaigns in accordance with embodiments of the invention include a plurality of product advertisements that contain sets of information or structured data describing one or more products and/or services that are the subject(s) of the product advertising campaign along with product targets that group the product advertisements. Product advertisement generation processes in accordance with embodiments of the invention can include generating product advertisements containing sets of information or structured data that are targeted toward keywords and/or phrases (and/or the intent described by the keywords and/or phrases) contained in search queries and/or content hosted on third-party content sites. The information and/or structured data in the product advertisements can be utilized by a search engine provider or third-party content provider to generate ad copy based on the product data in the product feed. In a variety of embodiments, ad copy is text describing the product in the product advertisement as displayed alongside the search results. In a number of embodiments, the product advertising campaign includes images, product titles, price information, and/or landing page references (e.g. uniform resource locators (URLs)) that are utilized by the search engine provider and/or third-party content provider to generate the advertising creative. Techniques for generating and deploying product listing advertising campaigns that can be utilized in accordance with embodiments of the invention are disclosed in U.S. Patent Publication No. 2014/0279037, filed Mar. 13, 2013, the disclosure of which is hereby incorporated by reference in its entirety.

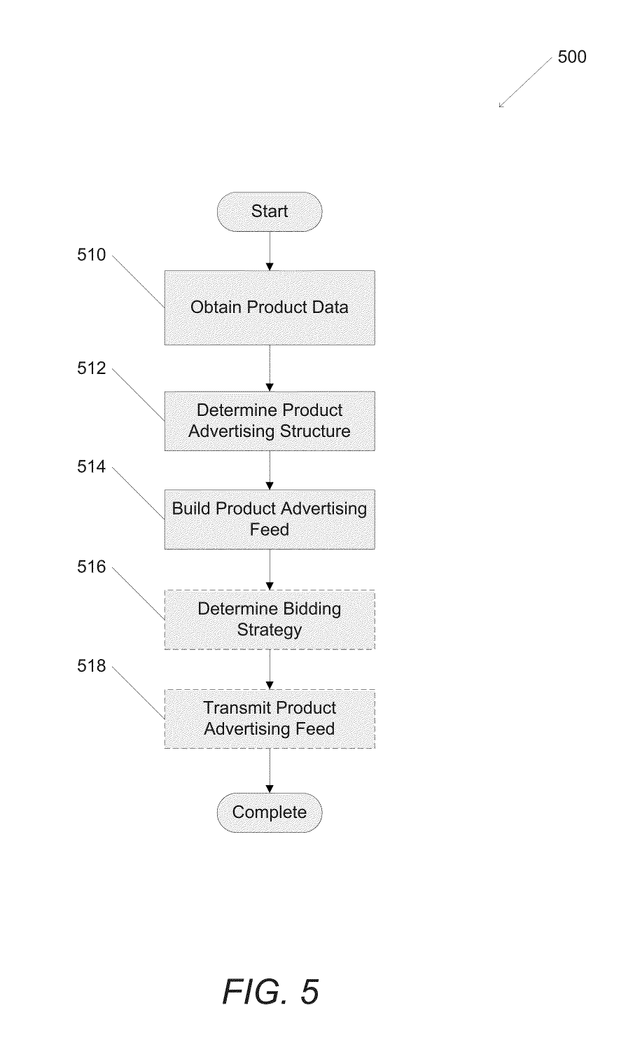

A process for generating product listing advertising campaigns in accordance with an embodiment of the invention is illustrated in FIG. 5. The process 500 includes obtaining (510) product data, determining (512) a product advertising structure, and building (514) a product advertising feed. In a variety of embodiments, a bidding strategy is determined (516) and/or the product advertising feed is transmitted (518).

Although specific processes for generating product listing advertising campaigns in accordance with embodiments of the invention are discussed above with respect to FIG. 5, any of a variety of processes can be utilized in accordance with embodiments of the invention.

### Generating Online Social Network Advertising Campaigns

A variety of online social networks (and other third-party content sites) can provide a variety of user-generated content. A portion of this content can identify one or more products and/or interests of the users of the online social network. In many embodiments, product advertisement generation processes include generating targeted advertising to be displayed on a third-party content server, such as an online social network. This advertising data can be displayed alongside the content of the site and/or be incorporated into the content of the online social network itself. Furthermore, the advertising data can be generated based on the content posted to the online social network. The advertising data can be targeted to individual users and/or to aggregated groups of users (or even the entire online social network) as appropriate to the requirements of specific applications of the invention. Insights gained by advertising on a particular online social network can also be propagated to advertising data generated for a second online social network, a search engine, or any other system that provides an advertising channel for displaying one or more advertising campaigns as appropriate to the requirements of specific applications of embodiments of the invention.

In many embodiments, product advertisement generation processes include obtaining content (or any other data) posted to the online social network. In several embodiments, the data is obtained using a coordinated product advertising server system. In many embodiments, the content includes a variety of keywords and/or other metadata describing the content, the user associated with the content, the performance of the content, and any other data as appropriate to the requirements of specific applications of the invention. The content can then be analyzed to determine categories and/or attributes present within the content using a taxonomy. In several embodiments, the content itself, performance data determined based on the content, and/or attributes of the content (such as image data, link data, and/or any other data) associated with the content can be incorporated into the taxonomy. Advertising data can then be generated using the keywords present in the obtained content, the categories and/or attributes present in the taxonomy, and/or any additional data inferred based on the keywords, categories, and attributes. In a number of embodiments, performance data related to the posting of content on the online social network can also be included in the taxonomy and the selection of keywords, categories, and/or attributes can be based on the performance data. For example, if a particular image of a product is identified as popular on an online social network (for example, by identifying multiple pieces of content posted to the online social network including the image), that image can be utilized in the generated advertisement data. In this way, high-performing content can be incorporated into the advertising campaign. In particular, it should be noted that this content can be utilized over content provided in a product feed even if the inferred content does not correspond to the product described in the product feed. In several embodiments, the generated advertisement data includes content to be posted on an online social network.

Additionally, the keywords and/or the performance data obtained and identified from the online social network can be utilized to modify existing advertising campaigns. Furthermore, this data can be utilized in the generation and/or modification of advertising campaigns provided for other advertising channels, such as targeted advertising campaigns and product listing advertising campaigns similar to those described above. This can allow for improved performance across multiple advertising channels by incorporating content (i.e. keywords, image data, video data, audio data, etc. . . . ), categories, and attributes identified in a particular advertising channel to be utilized in other advertising channels.

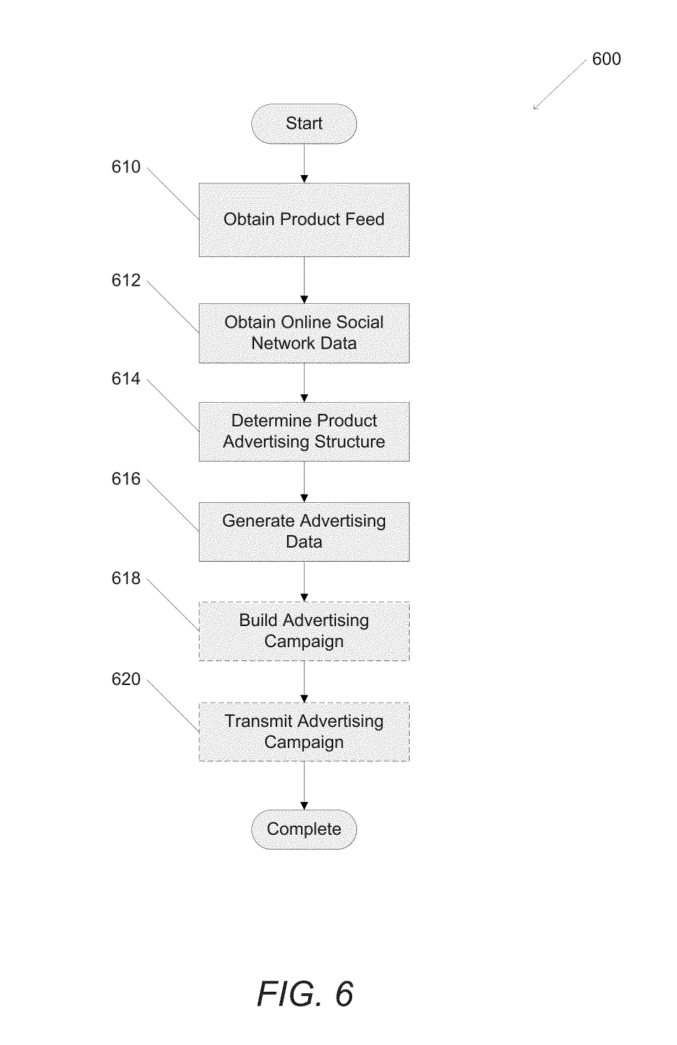

A process for generating online social networking advertising campaigns in accordance with an embodiment of the invention is illustrated in FIG. 6. The process 600 includes obtaining (610) a product feed, obtaining (612) online social network data, determining (614) a product advertising structure, and generating (616) advertising campaign. In a variety of embodiments, an advertising campaign is built (618) and/or transmitted (620).

While specific processes for generating online social networking advertising campaigns in accordance with embodiments of the invention are discussed above with respect to FIG. 6, any of a variety of processes, including those that generate targeting advertising and/or advertising campaigns for any third-party content system, can be utilized in accordance with embodiments of the invention.

### Generating Product Titles

A variety of product advertisement generation processes include generating titles and/or content for targeted advertising creatives. In many product advertising campaigns, the titles and/or content of the targeted advertising data does not properly represent a title and/or match user intent with respect to the products being advertised. Coordinated advertising campaigns in accordance with embodiments of the invention include titles and/or other content (i.e. metadata and/or content to be included in a message posted on an online social network) based on the attributes of the product feed. Additionally, these feed attributes or transform existing titles and/or content in existing targeted advertising campaigns to a more desirable form. Additionally, the generated titles and/or content can be analyzed and any duplicative titles and/or content can be updated (i.e. augmented) and/or removed from a particular targeted advertising campaign. In several embodiments, the titles and/or content are designed to fit within a content length requirement of the advertising channel to which the product advertisement is targeted. For example, a product listing advertising campaign title may be limited to 70 characters, while a message targeted toward an online social network may be limited to 140 characters. In this way, the generated titles and/or content can conform to the requirements of the advertising channel.

A variety of modifications can be applied to existing product titles and/or content. One or more attributes within the existing data can be normalized attributes, i.e. any attribute in a title can be replaced with the normalized version identified using the taxonomy. For example, the word “azure” can be replaced with “blue.” One or more attributes can be removed from the title and/or content. For example, a stock-keeping unit can be eliminated from the data. Similarly, particular attributes can be replaced with a different attribute. For example, a stock keeping unit can be replaced with color information. Additional attributes and/or text can also be inserted into the titles. Furthermore, any combination of titles and modifications to the titles can be interchanged in order to provide performance testing (e.g. A/B testing) of particular titles, content, categories, and/or attributes.

In a variety of product advertising campaigns, advertisements presented to users (e.g. the advertising creative) includes an image and a title (or any other tagline) describing the product. As such, it is extremely important to have titles that clearly describe the attributes of the product in a way that users will be encouraged to engage with the presented advertisement. In several embodiments, the most relevant attributes (i.e. dominant attributes) for the products being advertised are identified and utilized in generating the product titles. In this way, the product advertising campaigns generated in accordance with embodiments of the invention are designed to have product titles that are expected to perform well based on historical performance data aggregated across a variety of advertising campaigns. In a variety of embodiments, dominant attributes can be based on the category (or sub-category) of the product being advertised. In several embodiments, the product data feed may not include attributes corresponding to the identified dominant attributes and the product advertisement generation processes include requesting additional product data and/or inferring additional from the categories and attributes present in a taxonomy. Techniques for identifying and utilizing dominant attributes in the generation of product titles that can be utilized in accordance with embodiments of the invention are disclosed in U.S. patent application Ser. No. 14/875,366, titled “Systems and Methods for Dominant Attribute Analysis,” the disclosure of which is hereby incorporated by reference in its entirety.

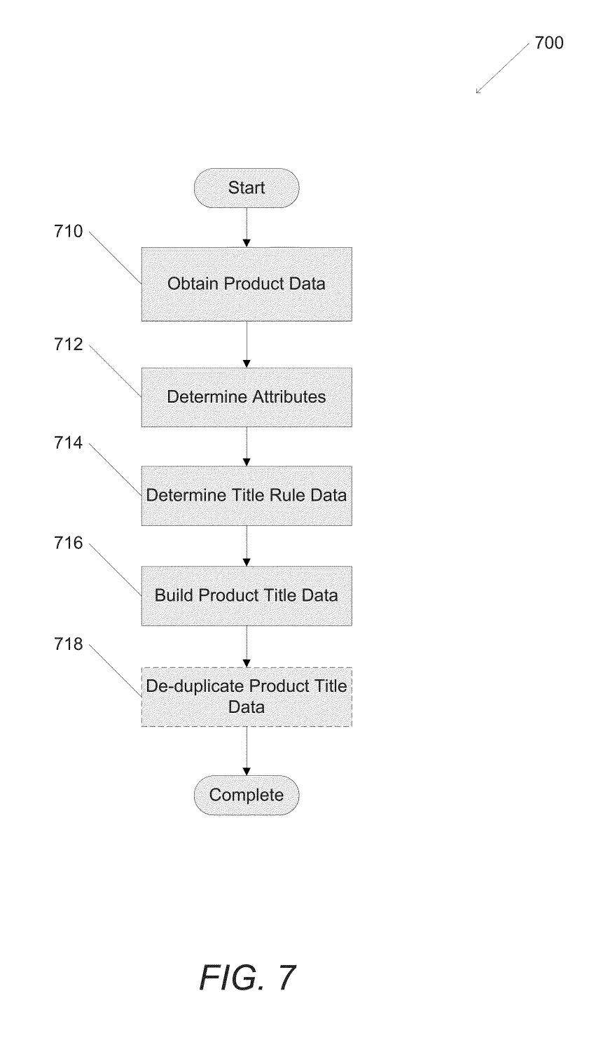

A process for generating product titles in accordance with an embodiment of the invention is illustrated in FIG. 7. The process 700 includes obtaining (710) product data, determining (712) attributes, determining (714) title rule data, building (716) product title data, and, in many embodiments, de-duplicating (718) product title data.

Specific processes for generating product titles in accordance with embodiments of the invention are described above; however, any of a variety of processes, including those that utilize techniques similar to those described above to generate metadata describing images, ad copy, landing page content, and/or messages to be posted on one or more online social networks, can be utilized as appropriate to the requirements of specific applications of embodiments of the invention.

### Advertising Retargeting

Several product advertisement generation processes include retargeting existing advertising across one or more advertising channels. In a variety of embodiments, particular users utilize a wide variety of sites on the Internet including, but not limited to, search engine providers, shopping sites, and online social networks. User data identifying a user across sites can be utilized to target advertising to the user across a variety of advertising channels based on the user data. In a variety of embodiments, the user data includes metadata describing user preferences based on keywords provided by the user, content viewed by the user, content generated by the user, and/or any other user-related data as appropriate to the requirements of specific applications of embodiments of the invention. In a number of embodiments, the keywords and/or metadata are described on a per-channel (i.e. on a per-site or service) basis. In this way, the user data can be utilized to target advertising from the various advertising campaigns for each of the sites visited by the user. Additionally, the user data can be utilized to generate advertising data for one or more advertising channels. In several embodiments, keywords and other metadata present in the user data are utilized to identify categories, attributes, and/or keywords using a taxonomy that is used to identify product data corresponding to the intent and/or interest expressed in the user data. The categories, attributes, keywords, and/or performance data in the taxonomy can be utilized in combination with the product data to generate advertising data targeted toward the user on one or more advertising channels as appropriate to the requirements of specific applications of embodiments of the invention.

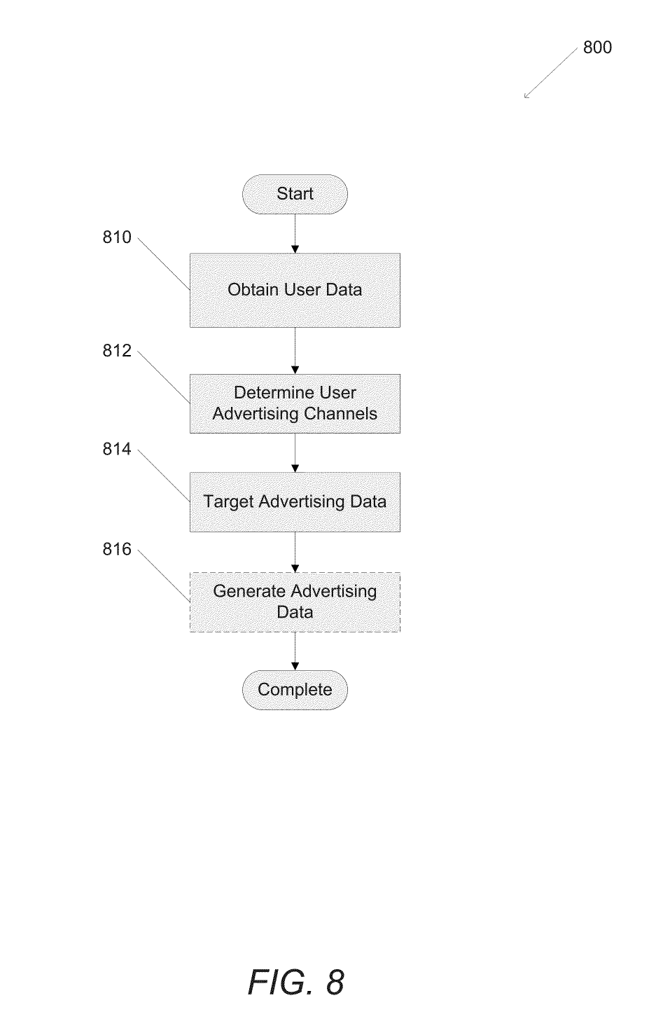

A process for re-targeting advertising data in accordance with an embodiment of the invention is shown in FIG. 8. The process 800 includes obtaining (810) user data, determining (812) user advertising channels, and targeting (814) advertising data.

In several embodiments, advertising data is generated (816). Specific processes for re-targeting advertising in accordance with embodiments of the invention are described above; however, any of a variety of processes, including those that utilize techniques similar to those described above to generate advertising data including images and/or messages to be posted on one or more online social networks, can be utilized as appropriate to the requirements of specific applications of embodiments of the invention.

### Generating Global Performance Data

Many product advertisement generation processes include measuring and/or monitoring the performance of advertising campaigns across a variety of advertising channels. As described above, performance data can be obtained across one or more advertising campaigns, where each advertising campaign is directed toward a particular advertising channel. This performance data can be encoded using the taxonomy in order to classify the performance data according to the categories, attributes, and/or keywords present in the taxonomy and the performance data. In many embodiments, the (encoded) performance data identifies a particular client and/or advertising campaign. The encoded performance data can be anonymized so that any unwanted data, such as but not limited to the specific client and/or advertising campaign, can be removed so that the source of the performance data cannot be determined. In a number of embodiments, the (encoded) performance data is aggregated across advertising channels and/or across clients. The aggregation can be based on any of a variety of criteria, such as advertising channel, client, category, attribute(s), keyword(s), or any other aspect of the performance data as appropriate to the requirements of specific applications of embodiments of the invention. The (encoded) performance data (and/or the anonymized and/or aggregated data) can be combined to form a set of global performance data describing the performance of particular categories, keywords, and/or attributes across a variety of advertising campaigns and/or advertising channels. In this way, the global performance data is agnostic to the advertising channel and/or advertising campaign and can thereby be used to enhance the performance of advertising campaigns across a variety of advertising channels and clients.

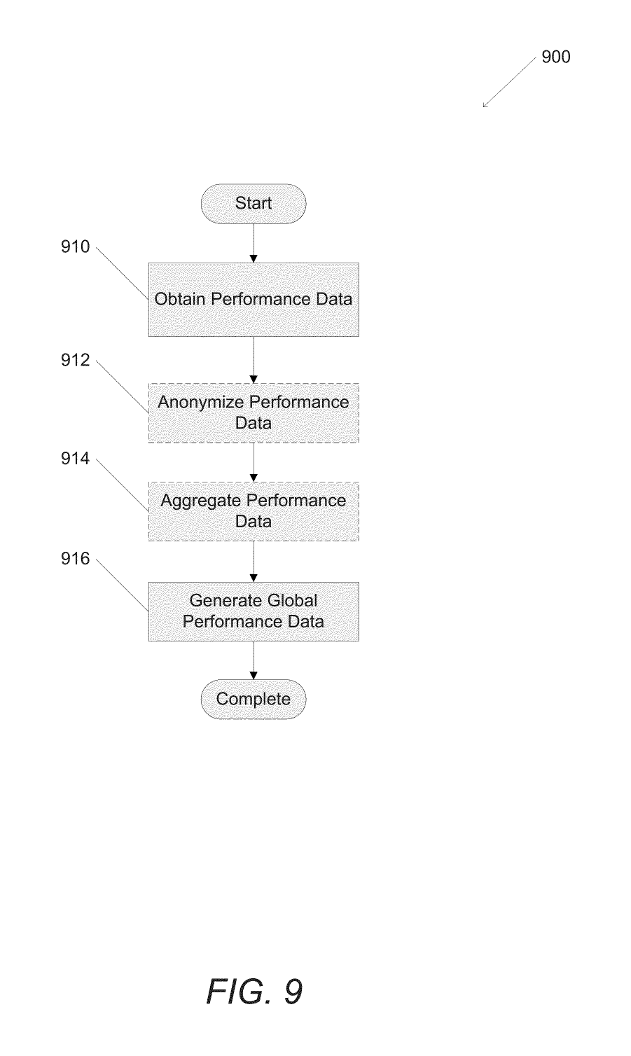

A process for generating global performance data in accordance with an embodiment of the invention is shown in FIG. 9. The process 900 includes obtaining (910) performance data. In several embodiments, performance data is anonymized (912) and/or aggregated (914). Global performance data is generated (916).

Specific processes for generating global performance data in accordance with embodiments of the invention are described above; however, any of a variety of processes, including those that encode performance data and utilize separate data structures for each advertising channel and/or advertising campaign, can be utilized as appropriate to the requirements of specific applications of embodiments of the invention.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A coordinated product advertising server system, comprising:
a processor; and
a memory connected to the processor and storing a product advertisement generation application;
wherein the product advertisement generation application directs the processor to:
obtain product feed data;
determine a set of advertising channel data, wherein advertising channel data comprises metadata describing attributes of an advertising channel;
generate a set of advertising creatives for each advertising channel based on the product feed data and the set of advertising channel data;
generate a set of product advertising campaigns, wherein an advertising campaign is targeted to a specific advertising channel and comprises the set of advertising creatives for the specific advertising channel; and
transmit each product advertising campaign to the specific advertising channel associated with the product advertising campaign.
